(19) United States
(12) Patent Application Publication
(10) Pub. No.: US 2024/0364660 A1
(43) Pub. Date: Oct. 31, 2024

(54) EFFICIENT ALLOCATION OF RANGE SUMMARIZATION RESOURCES FOR PACKET CLASSIFICATION

(71) Applicant: Arista Networks, Inc., Santa Clara, CA (US)

(72) Inventors: Ramakrishna Paduvalli, Saratoga, CA (US); Muhammad Khalid Yousuf, San Jose, CA (US)

(21) Appl. No.: 18/307,703

(22) Filed: Apr. 26, 2023

(51) Int. Cl. H04L 9/40; H04L 45/745

(52) U.S. Cl. CPC H04L 63/0263; H04L 45/74591

(57) ABSTRACT

Systems and methods for allocating entries of a summarization table to ranges of packet field values in hardware table entries. A plurality of rules to be stored in at least one hardware table (e.g., a TCAM), specify value ranges which are used to match packets. For each value range, a corresponding cost reduction (reduced number of required hardware table entries) that would result from replacing the packet field value range with a first entry in a summarization table is determined. A value range having the greatest cost reduction is then determined and this value range is assigned to a first entry in the summarization table. This process is repeated for subsequent summarization table entries, with the corresponding cost reductions taking into account effects of value ranges having previously been assigned to the summarization table.

### TECHNICAL FIELD

The disclosed embodiments relate generally to the use of field summarization tables in network devices, and more particularly to systems and methods for optimizing the allocation of entries in port summarization tables to enable the storage of increased numbers of classification rules in associated hardware tables of network devices.

### BACKGROUND

Network devices allow different hardware devices on a computer network to communicate and interact with each other. Some of the features of the network devices are implemented using functions such as packet classification. Packet classification may, for example, be used in the implementation of Access Control Lists (ACL), Policy Based Routing (PBR), or Quality of Service (QOS) policies.

The classification of packets is based on classification rules that are stored in various lookup-tables and hardware resources of a network device. Because the hardware resources of the network device are limited, there are a limited number of rules that can be stored in the tables of the network device.

The classification rules of a network device may include, for example, rules that are based on the source and destination ports of received packets. Such a rule may include fields that specify a range of source ports and a range of destination ports, where the rule applies to packets that have source and destination ports that fall within the specified ranges.

Conventionally, programming this rule into a hardware table of the network device would require a separate entry for each of the possible combinations of source and destination ports. For example, if the rule applies to a range of three source ports and a range of four destination ports, the rule would require 12 entries (3 source ports×4 destination ports).

In order to maximize the number of rules that can be stored in the hardware tables, a number of existing network devices support the use of port summarization tables. A port summarization table has multiple entries, each of which summarizes a range of ports. A result-bitmap register associated with the port summarization table has a bit corresponding to each entry in the port summarization table, where the bit is set if a packet has a port that falls within the range specified in the table entry. A single bit corresponding to a single entry in the port summarization table can therefore represent and effectively replace a range of values in a rule.

Thus, in the example above where the rule specifies ranges of three source ports and four destination ports, replacement of the range of three source ports by a single entry in the port summarization table would reduce the required number of entries for the rule in the hardware table from (3×4)=12 to (1×4)=4. The use of the port summarization table therefore significantly reduces the number of entries in the hardware table which are required to implement the rule.

While the use of port summarization tables in this manner is known, entries in the port summarization tables are not allocated in a systematic manner. Typically, a couple of entries may be pre-allocated to ‘well-known’ ranges, and the rest of the entries are allocated primarily with a locally assessed priority. For instance, they may be allocated to large ranges in the first few ACLs that are installed. Consequently, although some benefit will be achieved through the use of the port summarization tables, the allocation of the entries in these tables is not efficient and does not maximize the benefit that could be achieved.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a block diagram illustrating the relevant structure of an example network device in accordance with some embodiments.

FIG. 2 is a diagram illustrating an example of a hardware table for storing classification rules in accordance with some embodiments.

FIG. 3 is a diagram illustrating the structure of a rule in accordance with some embodiments.

FIG. 4 is a diagram illustrating a range of summarization table and a corresponding bit register in accordance with some embodiments.

FIG. 5 is a flow diagram illustrating an example process for analyzing possible summarization table allocations, selecting the value range providing the greatest cost reduction and allocating the summarization table entry to the selected value range in accordance with some embodiments.

FIG. 6 is a flow diagram illustrating the calculation of the number of entries required to store rules prior to allocation of a summarization table entry in accordance with some embodiments.

FIG. 7 is a flow diagram illustrating the calculation of the cost reduction associated with each possible allocation of a summarization table entry in accordance with some embodiments.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments disclosed herein involve the use of existing capabilities in network devices which use port summarization tables to reduce the numbers of hardware table entries that are required to store packet classification rules. Rather than pre-allocating entries in field summarization tables to well-known or predetermined ranges, or allocating the entries in just a few tables based on priorities associated with this limited number of tables, the present embodiments analyze the classification rules to be stored with a global view of the classification rules. That is, the allocation of the port summarization table entries are allocated based on all of the rules that are to be loaded into the hardware tables of an application specific integrated circuit used for forwarding packets (forwarding ASIC). Further, the port summarization table entries are allocated based on analyses of all of these rules which optimizes the allocation (i.e., achieves a minimized number of hardware table entries required to store the classification rules).

The disclosed embodiments perform an analysis for an available entry in a summarization table to select an optimal allocation for the entry, and then repeats the analysis and allocation for the next available entry, continuing this process until all of the available entries in the summarization table have been allocated. The analysis for each summarization table entry involves computing a cost reduction for each possible allocation of the entry, choosing the allocation that provides the greatest cost reduction, and then allocating the entry to the value range in the rules that corresponds to the allocation. When a summarization table entry is allocated to a value range used by a particular rule, the value range is then represented by a single entry in the hardware table, so this will affect the cost reductions that are thereafter computed for the rule. Consequently, for each iteration (where the iteration represents the computation of costs and cost reductions for a corresponding summarization table entry), the costs associated with the rules (and value range), and particularly associated with the rules having value ranges to which summarization table entries have been allocated, will have to be recalculated.

It should be noted that “optimized” is used here to refer to solutions that select value ranges to which port summarization table entries are allocated in a manner which systematically reduces the number of entries required to store the rules, but this should not be construed to imply that this encompasses only a single solution that achieves a single most efficient allocation. Similarly, “minimize” is used herein to systematically reducing the number of entries required to store the rules, but should not be construed to imply that the present embodiments encompass only solutions that achieve a single greatest reduction in the number of hardware table entries required to store the classification rules.

As noted above, packet classification is used in network devices to implement various features. These features may include, without limitation, access control lists, policy based routing, quality of service policies, and the like. The packet classification is achieved through the use of rules that implement user configured filters.

In one embodiment, the packet classification is implemented in a network device by a packet classification rules compiler. The compiler takes into account multiple lookup tables and hardware resources that are available and tries to load as many classification rules as possible into the tables. The compiler has a global view of all the rules that need to be loaded on the forwarding ASIC of the network device, so the compiler is able to optimally allocate the available resources. This global view of the rules contrasts with the much more limited perspective of, for example, inline processing, which compiles rules on a per-port/interface basis taking into consideration only the new rules/set-of-rules being added or deleted.

The packet classification rules compiler in the disclosed embodiments supports summarization of value ranges in the fields of rules. Summarization of value ranges is implemented using a summarization table that generates a bitmap corresponding to ranges in the entries of the table. If a packet is compared to the summarization table, the bit corresponding to an entry in the table is set if the packet field falls within the range identified by the entry. If the packet field does not fall within the range identified by the entry, the corresponding bit is not set.

Because the summarization table identifies whether the packet falls within any of the ranges identified by the entries of the table, it is not necessary for the rules stored in the hardware tables to determine whether the packet matches the individual values in this range. Consequently, the hardware tables do not have to include separate entries for each of the individual values in the range, and more rules can be stored in the hardware tables. For the purposes of this disclosure, “hardware tables” refers to ternary content addressable memory (TCAM) or similar value/mask based lookup tables.

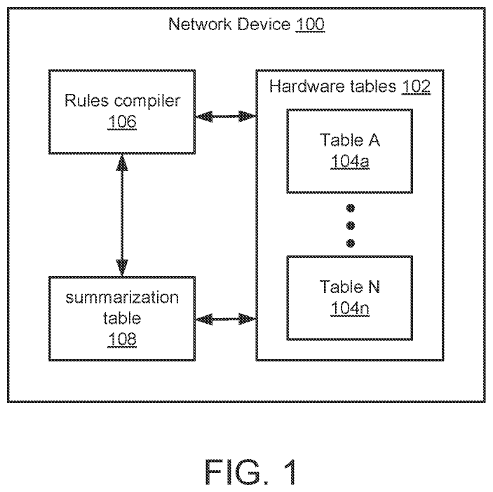

Referring to FIG. 1, a diagram illustrating the relevant structure of an example network device is shown. In this example, network device 100 contains hardware resources 102 which include a set of hardware tables 104a-104n. Hardware tables 104 are programmed with the rules that are required by network device 100 to perform the packet classification necessary to implement a set of features in the network device.

It should be noted that different instances of the same or similar devices may be identified herein by a common reference number followed by a letter. For instance, as depicted in FIG. 1, network device 100 includes individual hardware tables 104a-104n. The hardware tables may be referred to individually by the reference number and letter (e.g., “hardware table 104a”), or collectively by the reference number without the letter (e.g., “hardware tables 104”).

Network device 100 also includes a rules compiler 106 which is coupled to hardware tables 104. Rules compiler 106 is implemented in a processor of the network device and is configured to program the necessary rules into the hardware tables. Network device 100 further includes a summarization table 108 which is coupled to rules compiler 106 and hardware tables 104. Summarization table 108 contains a set of summarization entries, each of which is allocated to a corresponding value range of one or more fields in the rules stored in tables 104.

Rules compiler 106 is configured to manage the programming of rules into hardware tables 104, as well as the allocation of entries in summarization table 108 to corresponding value ranges associated with the rules stored in the hardware tables. As will be described in more detail below, rules compiler 106 examines the rules that are to be programmed into hardware tables 104 and identifies value ranges specified in the rules. Rules compiler 106 then analyzes the rules and associated value ranges to determine the cost reductions that are achievable by allocating entries in summarization table 108 to different ones of the value ranges. Based on these analysis and the cost reductions, rules compiler 106 selects particular ones of the value ranges to which entries of summarization table 108 will be allocated to maximize the cost reduction achieved through use of the summarization table.

As used herein, “cost reduction” refers to a reduction in the number of hardware table entries that are required to store the rule with its various possible alternative field values. Thus, if a rule requires six hardware table entries to store the rule without the summarization of field value ranges, and allocation of a summarization table entry to one of the fields results in only two hardware table entries being required to store the rule, the allocation of the summarization table entry would achieve a cost reduction of four (6-2) entries.

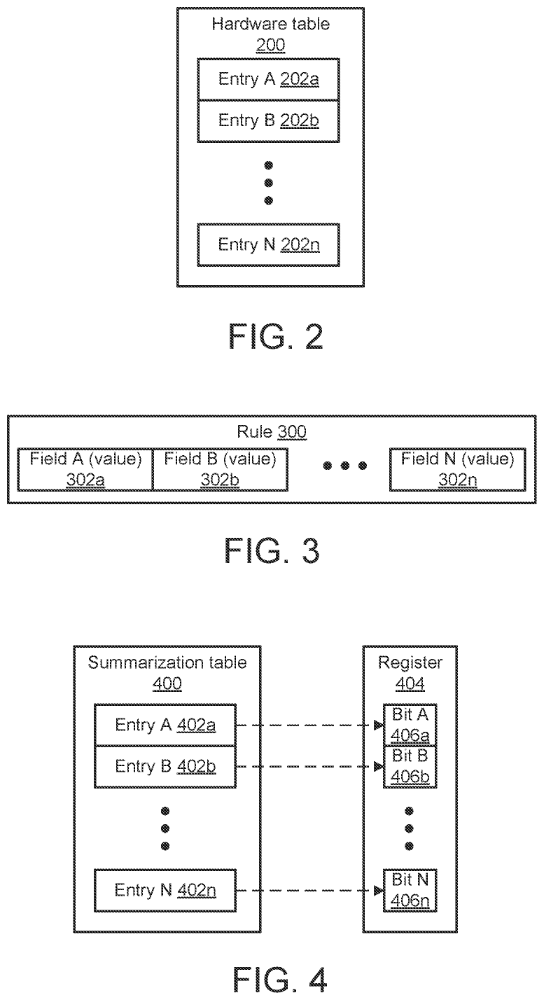

Referring to FIG. 2, a diagram illustrating an example of a hardware table for storing classification rules is shown. In this example, hardware table 200 includes a set of entries 202. Each entry stores a corresponding rule. More specifically, each entry stores a rule with a specific combination of field values. Thus, if a rule has two fields, one of which has two possible values and the other of which has three possible values, the rule will occupy six entries 202 in hardware table 200. If the rule has three fields, each having two possible values, the rule will occupy eight (2×2×2) entries. Hardware table 200 is not limited to a single rule, but may include multiple different rules.

The hardware table (e.g., TCAM) that is used for matching rules has, in each entry, a value (V) and a mask (M). The value (V) is a numeric value which is up to N bits long. The mask (M) comprises N bits, each having a binary value of 0 or 1. Thus, the match criterion for each entry in the table is the corresponding pair (V, M), and a value X of a field in a particular packet matches the rule if (X & M)==(V & M), where “&” is the bitwise logical AND operator.

Referring to FIG. 3, a diagram illustrating the structure of a rule in accordance with some embodiments is shown. As depicted in this figure, rule 300 has a set of fields 302. Generally, a “rule” is a fixed collection of packet fields. A “field” is a set of values that can be matched to the packet. Each field represents an attribute associated with the packets that are processed according to the rule. For example, the fields may correspond to a source port of the packet, a destination port of the packet, a source prefix or a destination prefix, or any of a variety of other attributes. Each of fields 302 of rule 300 specifies one or more values that satisfy the rule. Some of the values are individual values, while others are ranges of values.

Below is an example of a rule (R1) with 4 fields:

$$R 1 : srcPrefix = [ a , b ] , dstPrefix = [ c , b ] , \\ srcPort = [ 10 - 20 , 45 ] , dstPort = [ 80 , 8080 ]$$

The fields include the source prefix (srcPrefix), the destination prefix (dstPrefix), the source port (srcPort) and the destination port (dstPort). Three of the fields (srcPrefix, dstPrefix and dstPort) each have 2 individual values that satisfy the rule. The other field (srcPort) has a range (10-20) and an individual value (45). Range 10-20 encompasses eleven values that can be expressed as a (value, mask) set < (0x10, 0x1c), (0xc, 0x1e), (0xa, 0x1a)>.

Referring to FIG. 4, a diagram illustrating a summarization table and a corresponding bit register in accordance with some embodiments is shown. As depicted in this figure, summarization table 400 comprises a set of entries 402. Each entry in the summarization table is allocated to a corresponding value range which appears in one or more of the packet classification rules stored in the hardware tables of the network device.

Then a packet is received by the network device, it is examined to determine whether the attributes of the packet fall within any of the ranges stored in entries 402 of summarization table 400. If the packet satisfies one of entries 402, a corresponding bit 406 in register 404 is set.

For example, if the packet has a field value that falls within a range identified in entry A (402a) of summarization table 400, then the corresponding bit (Bit A, 406a) of register 404 is set. If the packet does not fall within the range identified in entry A (402a) of summarization table 400, then the corresponding bit (Bit A, 406a) of register 404 is not set. The packet is compared to the ranges associated with each of entries 402 in summarization table 400, so that each of bits 406 in register 404 is set (or not) to identify whether or not the corresponding range in the summarization table is satisfied by a value in a field of the packet.

Because the bit register of the summarization table identifies whether attributes of the received packet fall within the ranges associated with the entries of the summarization table, it is not necessary to program the hardware tables with each of the different variations of the rules that use the individual values within these ranges. The range is treated in the hardware tables as a single value, and the bit register of the summarization table identifies whether that effective value (the value range) is satisfied. Because the value range is treated as a single value, less entries are required to program the corresponding rule(s) into the hardware table(s).

While existing systems use summarization tables to reduce the number of entries that are necessary to store rules in the hardware tables, existing systems do not allocate the summarization table entries in a systematic way, and consequently do not optimize the use of the summarization table and consequently do not optimize the hardware (e.g., TCAM) lookup tables. In the disclosed embodiments, an efficient allocation of summarization table entries will result in reduced hardware table usage. Since existing systems typically pre-allocate some entries to “well-known” ranges and allocate the rest of the entries based on local priorities, they do not efficiently allocate summarization table entries.

In the embodiments disclosed herein, all of the rules to be loaded into the hardware tables (rather than a limited set of the rules) are examined to determine which ranges in these rules should be mapped to the summarization table entries. The allocation of the summarization table entries in the disclosed embodiments involves computing a cost reduction for each possible allocation of a summarization table entry and allocating the entry to the range that provides the greatest cost reduction (i.e., the greatest reduction in the number of hardware table entries required to store the rule). This is repeated until each of the entries in the summarization table has been allocated to a corresponding field value range in the rules.

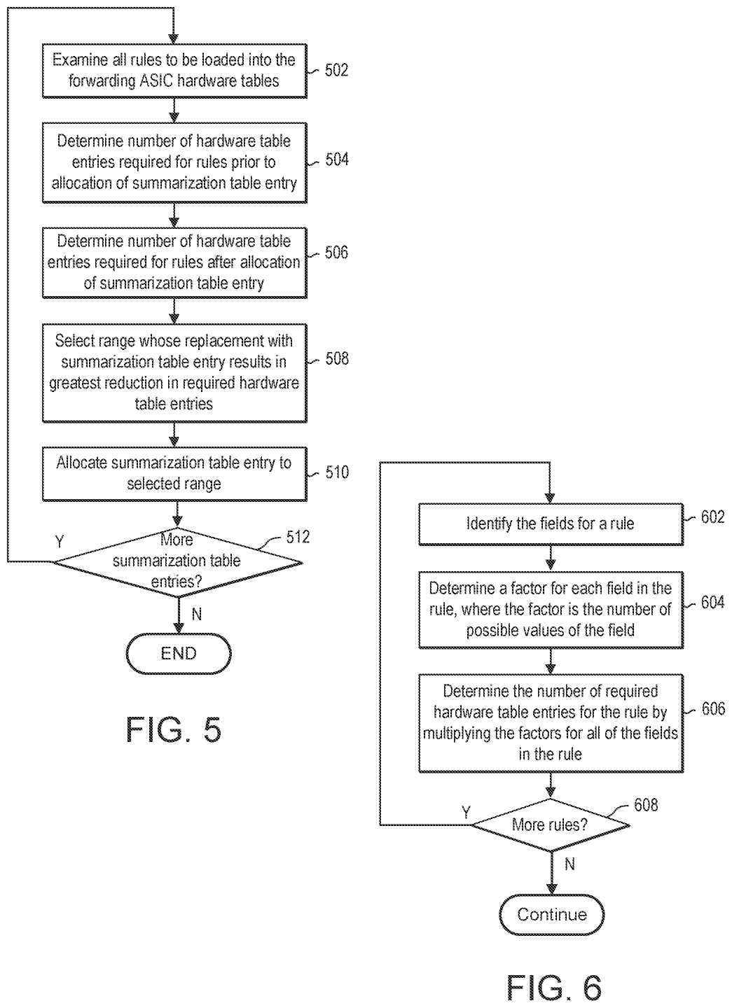

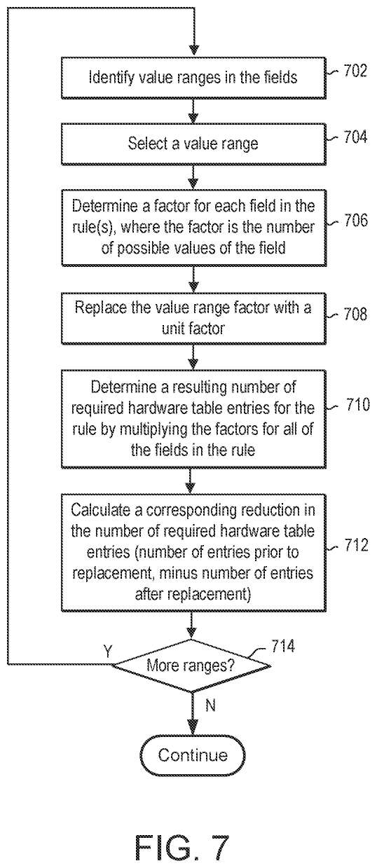

The process of allocating the summarization table entries to the field value ranges in the rules is described in more detail below with respect to FIGS. 5-7. FIG. 5 is a flow diagram illustrating an example of the overall process of analyzing the possible summarization table allocations, selecting the value range providing the greatest cost reduction and allocating the summarization table entry to the selected value range. FIG. 6 is a flow diagram illustrating the calculation of the cost (number of entries required to store the rules) prior to allocation of a summarization table entry. FIG. 7 is a flow diagram illustrating the calculation of the cost reduction associated with each possible allocation of a summarization table entry.

Referring to FIG. 5, a method for allocation of summarization table entries to field value ranges by an optimizing packet classification rules compiler in accordance with some embodiments is shown. This method is performed for each available entry of the summarization table to be allocated.

The rules compiler has a global view of the rules, so it is capable of accessing all of the rules that need to be loaded on the forwarding ASIC of the network device, so the compiler is able to optimally allocate the summarization table entries based on all of these rules. The rules compiler therefore examines all of these rules (502).

The rules compiler then determines the number of hardware table entries that are required to store the rules (the cost of the rules) prior to the allocation of the summarization table entry to any of the field value ranges (504). After the pre-allocation cost of the rules has been determined, the rules compiler determines the cost of the rules with each possible allocation of the summarization table entry (506). In other words, the rules compiler determines, for each field value range, what the cost of the rules would be if the field value range were allocated to the summarization table entry (i.e., If the multiple possible values within the value range were replaced by a single value).

Because the cost of the rules after allocation of the summarization table entry to a field value range will be less than or equal to the pre-allocation cost, each value range will have an associated cost reduction (pre-allocation cost-post-allocation cost). The rules compiler therefore selects, from among all of the value ranges to which the summarization table entry may be allocated, a range which has the greatest associated cost reduction (508). If there are multiple value ranges which achieve this greatest cost reduction, the rules compiler may select any of these value ranges. Alternatively, the rules compiler may implement an alternative algorithm which takes into account other factors which are used as the basis for selecting a particular one of these value ranges. The rules compiler then allocates the summarization table entry to the selected field value range (510).

As noted above, the process of steps 502-510 is performed for each summarization table entry to be allocated, so following the allocation of the summarization table entry in step 510, the rules compiler determines whether there are additional summarization table entries to be allocated (512). If there are additional entries, the rules compiler repeats the process. Otherwise, the summarization table has been completely allocated, and the process terminates.

It should be noted that, the method of FIG. 5, as well as other methods disclosed herein, Is intended to be illustrative, rather than limiting. Alternative embodiments may perform the described steps in a different order, or the described functions may be distributed among the steps in a different manner. For example, rather than computing cost for all of the rules collectively prior to determining cost reductions associated with allocation of summarization table entries to particular field value ranges, one alternative method may determine the pre-allocation cost of an individual rule at or around the same time the post-allocation cost of the rule is determined.

Referring to FIG. 6 a flow diagram illustrating an example of the calculation of the cost of storing the rules (i.e., the number of entries required to store the rules) prior to allocation of a summarization table entry is shown. This method is performed for each of the rules to be stored in the hardware tables.

The rules compiler first identifies the fields that are included in a rule (602). For each field, a factor is determined to identify the number of possible values of the field (604). For instance, if the field has only a single value, the factor is 1. If there are a number, N, of individual values that are possible, the factor is N (see rule R1 above, in which each of fields srcPrefix, dstPrefix and dstPort has two individual possible values). if there is a single range of values that encompasses a number, M, of values, the factor is M. If there is a combination of individual values and a value range, the factor includes the number of the individual values, and the number of possible values encompassed by the range (see rule R1 above, in which field srcPort includes eleven possible values in range “10-20” and a single individual value, “45”).

After a factor has been determined for each of the different fields of the rule, all of these factors are multiplied to generate a product which represents the number of hardware table entries that are required to store all of the possible combinations of field values that could satisfy the rule (606). This is the cost associated with the rule (prior to allocation of a summarization table entry to represent any value ranges included in the rule). After this pre-allocation cost for the rule has been determined, the rules compiler determines whether or not there are additional rules for which the cost must be determined (608). If so, the process is repeated for the next rule. Otherwise, the method continues to determine the post-allocation cost of the rules.

Referring to FIG. 7, a flow diagram is shown to illustrate an example method performed by the rules compiler for calculation of the cost reduction associated with each possible allocation of a summarization table entry. Initially, the rules are examined to identify value ranges that are specified in the fields of the rules (702). Since the purpose of this process is to identify a value range to be allocated to an entry in the summarization table, only unallocated value ranges are considered here. One of the identified value ranges is then selected (704). The selected value range may occur one or more times in one or more of the rules.

For at least the rules that contain the selected value range, factors associated with each of the fields are determined (706). The factor (or portion of the factor) associated with the selected value range is then replaced with a unit factor (708) since the allocation of the selected value range to an entry in the summarization table would replace the number of hardware table entries required for the value range by a single hardware table entry. In other words, the multiple values of the range are treated as a single value. For instance, in the example of rule R1 above, the range “10-20” in the srcPort field would contribute only 1 to the factor for the field instead of eleven. The factor for the srcPort field would therefore be (1+1) instead of (11+1).

The rules compiler then determines the number of hardware table entries that would be required to store the rule (with its various combinations of field values) in the hardware tables by multiplying the factors for each rule that contains the selected value range (710). This product of the factors which takes into account the effect of allocating the value range to the summarization table entry is then compared to the product of the factors which do not take this into account (i.e., which do not replace the number of values in the range with 1) to determine the reduction in the number of hardware table entries that results from the allocation of the value range to the summarization table entry (712).

The calculation of the pre-allocation cost, post-allocation cost and cost reduction is performed separately for each rule that includes the selected value range. If the selected value range is found in multiple rules, the cost reduction associated with allocating the selected value range to a summarization table entry is determined separately for each rule, and then the cost reductions for the different rules are added together. The total cost reduction is associated with the selected value range. The total cost reduction associated with the selected value range is stored so that it can be compared to the cost reductions associated with other value ranges to determine which one provides the greatest cost reduction. After the cost reduction associated with the selected value range is calculated and stored, it is determined whether there are additional field value ranges for which corresponding cost reductions need to be calculated (714). If so, another value range is selected and the process is repeated. Otherwise, the overall process continues with the comparison of cost reductions and selection of the value range with the greatest cost reduction.

Following is an example of an optimizing rules compiler for classification of packets upon ingress to a network device. In this embodiment, the network device may use TCAM as a hardware lookup table for rules that use L4 source and destination port ranges. Because TCAM is very power hungry, it is very important to minimize the number of TCAM entries that are required to store the classification rules. A summarization table is therefore used to minimize the number of required TCAM entries. The summarization table is used as a port range lookup table (L4Ops table). The summarization table generates a bitmap result that shows whether ingress packets fall within ranges that are identified in the rules and are allocated to the summarization table.

The summarization table is used to implement L4 port matching of packets on ingress to the network device. This table has multiple rows, where each row contains minimum and maximum values of a source port and a destination port (source_port_min, source_port_max, destination_port_min, destination_port_max).

The summarization table produces a bitset in which each bit is set to true if a packet's L4 source and destination ports match the criteria programmed in the corresponding summarization table entry. The summarization table entry index is the bit offset in the bitset. Thus, the relevant bit of bitset is set to “1” if:

$$( source\_port >= {source\_port}_{-} min )$$

$$and ( source\_port <= source\_port \_max )$$

$$and ( destination\_port >= {destination\_port}_{-} min )$$

$$and ( destination\_port <= {destination\_port}_{-} max )$$

If a user wants a summarization table entry to disregard source port matching and only match on the destination port, then source_port_min can be set to 0, and source_port_max can be set to 0xffff for the entry. As a result, any source port will be within the range, and the packet will be matched based only on the destination port.

Since the optimizing rules compiler compiles all the traffic-policies for a forwarding ASIC, it has a global view of all rules across all traffic-policies applied on interfaces for that forwarding ASIC. The compiler therefore implements an allocation algorithm that provides the greatest reduction in TCAM usage by summarizing port ranges in the rules.

Rule R1 (shown above) has four fields, each of which specifies corresponding field values that satisfy the rule:

$$srcPrefix = [ a , b ]$$

$$dstPrefix = [ c , b ]$$

$$srcPort [ 10 - 20 , 45 ]$$

$$dstPort = [ 80 , 8080 ]$$

Fields srcPort and dstPort are collections of non-overlapping ranges. Ranges for these two fields are defined in entries of the summarization table.

The number of TCAM entries generated for each rule is the product of the number of entries for each field. In this example, field “srcPrefix” has two entries, field dstPrefix has two entries, field srcPort has twelve (11+1) entries, and field dstPort has two entries. Consequently, without allocation of a summarization table entry to the range “10-20”, rule R1 will generate 2×2×(11+1)×2=96 TCAM entries. If a summarization table entry is allocated to range “10-20”, the range can be represented with just one entry instead of eleven. This would reduce the required number of TCAM entries to 2×2×(1+1)×2=16 TCAM entries. This is a cost reduction of 80 entries.

The optimizing rules compiler is configured to allocate summarization table entries to corresponding ranges that result in the greatest reduction in the number of TCAM entries that are required to store the rules. The compiler therefore performs calculations similar to those described above for rule R1 for all of the other rules having field value ranges that have not been allocated to summarization table entries. The corresponding cost reductions associated with each of the possible value range allocations are compared to determine which allocation provides the greatest cost reduction. This allocation is made and, if there are additional summarization table entries that can be allocated, the process is repeated for each successive summarization table entry. In this embodiment, the cost reduction calculations are repeated after each summarization table allocation, because the preceding allocation(s) may change the factors.

It should be noted that the greatest cost reductions may not always be associated with the ranges that constitute the highest number of field values. For example, consider rules R2 and R3:

$$R 2 : \to srcPrefix = [ a , b , c , d ] , dstPrefix = [ b , c , d , e ] , \\ srcPort = [ 3 - 4 ] , dstPort = [ 80 , 8080 ]$$

$$R 3 : srcPrefix = [ a , b ] , dstPrefix = [ c , b ] , \\ srcPort = [ 10 - 12 , 45 ] , dstPort = [ 80 , 8080 ]$$

Between Rule R2 and Rule R3, there are two ranges (3-4 and 10-12) that are considered for allocation of a summarization table entry. Although “10-12” in R3 represents three possible values and “3-4” in R2 represents two possible values, allocation of a summarization table entry to the range 3-4 provides a greater cost reduction than allocating the entry to the range 10-12. This is due to the fact that the other factors in R2 are greater. For R2, the pre-allocation cost is (4×4×2×2=64), and the post-allocation cost is (4×4×1×2=32), resulting in a cost reduction of (64−32=32). In the case of R3, the pre-allocation cost is (2×2×4×2=32), and the post-allocation cost is (2×2×2×2=16), resulting in a cost reduction of (32−16=16). Thus, even though allocation of a summarization table entry to the range 10-12 reduces a greater number of attribute values to a single range, values from other fields (e.g., srcPrefix and dstPrefix) also play a role in determining the optimal allocation and in this case cause the allocation of the smaller number of attribute values in R2 to provide a greater cost reduction. Thus, even values from other fields (e.g., srcPrefix and dstPrefix) also play a role in determining the optimal allocation.

Although the allocation of summarization table entries in this example involves only ranges in the srcPort field, it can operate on ranges in other fields without any loss of generality.

Several examples of alternative embodiments are provided below. Based on the disclosure herein, various additional alternative embodiments will also be apparent to those of skill in the art.

One embodiment comprises method for allocating entries of a summarization table to ranges of packet field values in entries of at least one hardware table of a network device. This method comprises examining a plurality of rules to be stored in at least one hardware table (e.g., a TCAM), where at least one of the rules specifies corresponding packet field value ranges which are used to match packets. For each packet field value range, a corresponding cost reduction that would result from replacing the packet field value range with a first entry in a summarization table is determined. A first packet field value range corresponding to a greatest cost reduction is then determined and the first packet field value range is assigned to a first entry in the summarization table.

The cost reduction may comprise a difference between: a number of hardware table entries required to store the plurality of rules prior to assigning the first packet field value range to the first entry in the summarization table; and a number of hardware table entries that would be required to store the plurality of rules after assigning the first packet field value range to the first entry in the summarization table.

The method may include, after assigning the first packet field value range to the first entry in the summarization table, iteratively performing this process for each of one or more additional entries in the summarization table. This may include examining the plurality of rules, determining the cost reduction for each unallocated packet field value range, identifying a corresponding additional packet field value range corresponding to a greatest cost reduction, and assigning the corresponding additional packet field value range to the corresponding entry in the summarization table. For each remaining packet field value range in the plurality of rules, the cost reduction corresponding to the packet field value range that would result from replacing the packet field value range with a second entry in the summarization table is determined based on previously assigned packet field value ranges being replaced by corresponding entries in the summarization table.

In some embodiments, determining the cost reduction corresponding to each packet field value range comprises, for a rule that contains the packet field value range: determining a factor for each field in the rule, the factor comprising a number of possible values for the field, the packet field value range comprising two or more of the possible values; multiplying all of the factors for the rule to produce a first product; updating the factors to represent the packet field value range as a single possible value; multiplying all of the updated factors for the rule to produce a second product; and subtracting the second product from the first product to produce the cost reduction corresponding to the packet field value range.

In some embodiments, the plurality of rules comprises a plurality of packet classification rules for classifying ingress and egress packets received by the network device, and the rules may include all of the packet classification rules to be loaded on a forwarding ASIC of the network device. The plurality of rules may define L4 source port ranges and L4 destination port ranges for classification of packets.

Another alternative embodiment comprises an optimizing rules compiler. This compiler comprises a processor coupled to one or more memories. The processor is configured to: examine a plurality of rules to be stored in at least one hardware table (e.g., a TCAM) in the one or more memories, at least one of the rules specifying one or more corresponding packet field value ranges which are used to match packets; for each packet field value range, determine a corresponding cost reduction that would result from replacing the packet field value range with a first entry in a summarization table stored in the one or more memories; identify a first packet field value range corresponding to a greatest cost reduction; and assign the first packet field value range to a first entry in the summarization table.

The optimizing rules compiler may determine the cost reduction by determining a difference between: a number of hardware table entries required to store the plurality of rules prior to assigning the first packet field value range to the first entry in the summarization table; and a number of hardware table entries that would be required to store the plurality of rules after assigning the first packet field value range to the first entry in the summarization table.

In some embodiments, the optimizing rules compiler is configured to, after assigning the first packet field value range to the first entry in the summarization table, iteratively perform this process for each of one or more additional entries in the summarization table. The process includes examining the plurality of rules, determining the cost reduction for each unallocated packet field value range, identifying a corresponding additional packet field value range corresponding to a greatest cost reduction, and assign the corresponding additional packet field value range to the corresponding entry in the summarization table. For each remaining packet field value range in the plurality of rules, the cost reduction corresponding to the packet field value range that would result from replacing the packet field value range with a second entry in the summarization table is determined based on previously assigned packet field value ranges being replaced by corresponding entries in the summarization table.

The optimizing rules compiler may determine the cost reduction corresponding to each packet field value range by, for a rule that contains the packet field value range: determining a factor for each field in the rule, the factor comprising a number of possible values for the field, the packet field value range comprising two or more of the possible values; multiplying all of the factors for the rule to produce a first product; updating the factors to represent the packet field value range as a single possible value; multiplying all of the updated factors for the rule to produce a second product; and subtracting the second product from the first product to produce the cost reduction corresponding to the packet field value range.

In some embodiments, the plurality of rules comprises a plurality of packet classification rules for classifying ingress packets received by the network device, where the plurality of rules comprises all packet classification rules to be loaded on a forwarding ASIC of the network device.

Another alternative embodiment comprises a computer program product comprising a non-transitory computer-readable medium storing instructions executable by one or more processors. The instructions are executable to perform: examining a plurality of rules to be stored in at least one hardware table, at least one of the rules specifying one or more corresponding packet field value ranges which are used to match packets; for each packet field value range, determining a corresponding cost reduction that would result from replacing the packet field value range with a first entry in a summarization table; identifying a first packet field value range corresponding to a greatest cost reduction; and assigning the first packet field value range to a first entry in the summarization table.

In some embodiments, the instructions are further executable to, after assigning the first packet field value range to the first entry in the summarization table, iteratively perform the process for each of one or more additional entries in the summarization table. This process includes examining the plurality of rules, determining the cost reduction for each unallocated packet field value range, identifying a corresponding additional packet field value range corresponding to a greatest cost reduction, and assigning the corresponding additional packet field value range to the corresponding entry in the summarization table. For each remaining packet field value range in the plurality of rules, the cost reduction corresponding to the packet field value range that would result from replacing the packet field value range with a second entry in the summarization table is determined based on previously assigned packet field value ranges being replaced by corresponding entries in the summarization table.

In some embodiments, determining the cost reduction corresponding to each packet field value range comprises, for a rule that contains the packet field value range: determining a factor for each field in the rule, the factor comprising a number of possible values for the field, the packet field value range comprising two or more of the possible values; multiplying all of the factors for the rule to produce a first product; updating the factors to represent the packet field value range as a single possible value; multiplying all of the updated factors for the rule to produce a second product; and subtracting the second product from the first product to produce the cost reduction corresponding to the packet field value range.

It will be understood that while specific embodiments have been presented herein, these embodiments are merely illustrative, and not restrictive. Rather, the description is intended to describe illustrative embodiments, features and functions in order to provide an understanding of the embodiments without limiting the disclosure to any particularly described embodiment, feature or function, including any such embodiment feature or function described. While specific embodiments of, and examples for, the embodiments are described herein for illustrative purposes only, various equivalent modifications are possible within the spirit and scope of the invention, as those skilled in the relevant art will recognize and appreciate.

As indicated, these modifications may be made in light of the foregoing description of illustrated embodiments and are to be included within the spirit and scope of the disclosure. Thus, while particular embodiments are described, a latitude of modification, various changes and substitutions are intended in the foregoing disclosures, and it will be appreciated that in some instances some features of embodiments of the invention will be employed without a corresponding use of other features, and features described with respect to one embodiment may be combined with features of other embodiments without departing from the scope and spirit of the disclosure as set forth.

What is claimed is:

1. A method for allocating entries of a summarization table to ranges of packet field values in entries of at least one hardware table of a network device, the method comprising:
examining a plurality of rules to be stored in at least one hardware table, at least one of the rules specifying one or more corresponding packet field value ranges which are used to match packets;
for each packet field value range, determining a corresponding cost reduction that would result from replacing the packet field value range with a first entry in a summarization table;
identifying a first packet field value range corresponding to a greatest cost reduction; and
assigning the first packet field value range to a first entry in the summarization table.

2. The method of claim 1, wherein the cost reduction comprises a difference between: a number of hardware table entries required to store the plurality of rules prior to assigning the first packet field value range to the first entry in the summarization table; and a number of hardware table entries that would be required to store the plurality of rules after assigning the first packet field value range to the first entry in the summarization table.

3. The method of claim 1, further comprising:
after assigning the first packet field value range to the first entry in the summarization table, iteratively performing for each of one or more additional entries in the summarization table:
examining the plurality of rules,
determining the cost reduction for each unallocated packet field value range,
identifying a corresponding additional packet field value range corresponding to a greatest cost reduction, and
assigning the corresponding additional packet field value range to the corresponding entry in the summarization table.

4. The method of claim 3, wherein for each remaining packet field value range in the plurality of rules, the cost reduction corresponding to the packet field value range that would result from replacing the packet field value range with a second entry in the summarization table is determined based on previously assigned packet field value ranges being replaced by corresponding entries in the summarization table.

5. The method of claim 1, wherein determining the cost reduction corresponding to each packet field value range comprises:
for a rule that contains the packet field value range:
determining a factor for each field in the rule, the factor comprising a number of possible values for the field, the packet field value range comprising two or more of the possible values;
multiplying all of the factors for the rule to produce a first product;
updating the factors to represent the packet field value range as a single possible value;
multiplying all of the updated factors for the rule to produce a second product; and
subtracting the second product from the first product to produce the cost reduction corresponding to the packet field value range.

6. The method of claim 1, wherein the plurality of rules comprises a plurality of packet classification rules for classifying ingress and egress packets received by the network device.

7. The method of claim 6, wherein the plurality of rules comprises all packet classification rules to be loaded on a forwarding ASIC of the network device.

8. The method of claim 1, wherein the plurality of rules define L4 source port ranges and L4 destination port ranges for classification of packets.

9. The method of claim 1, wherein the at least one hardware table comprises a ternary content addressable memory (TCAM).

10. An optimizing rules compiler comprising:
a processor coupled to one or more memories, wherein the processor is configured to:
examine a plurality of rules to be stored in at least one hardware table in the one or more memories, at least one of the rules specifying one or more corresponding packet field value ranges which are used to match packets;
for each packet field value range, determine a corresponding cost reduction that would result from replacing the packet field value range with a first entry in a summarization table stored in the one or more memories;
identify a first packet field value range corresponding to a greatest cost reduction; and
assign the first packet field value range to a first entry in the summarization table.

11. The optimizing rules compiler of claim 10, wherein the cost reduction comprises a difference between: a number of hardware table entries required to store the plurality of rules prior to assigning the first packet field value range to the first entry in the summarization table; and a number of hardware table entries that would be required to store the plurality of rules after assigning the first packet field value range to the first entry in the summarization table.

12. The optimizing rules compiler of claim 10, wherein the processor is configured to:
after assigning the first packet field value range to the first entry in the summarization table, iteratively perform for each of one or more additional entries in the summarization table:
examine the plurality of rules,
determine the cost reduction for each unallocated packet field value range,
identify a corresponding additional packet field value range corresponding to a greatest cost reduction, and
assign the corresponding additional packet field value range to the corresponding entry in the summarization table.

13. The optimizing rules compiler of claim 12, wherein for each remaining packet field value range in the plurality of rules, the cost reduction corresponding to the packet field value range that would result from replacing the packet field value range with a second entry in the summarization table is determined based on previously assigned packet field value ranges being replaced by corresponding entries in the summarization table.

14. The optimizing rules compiler of claim 10, wherein determining the cost reduction corresponding to each packet field value range comprises:
for a rule that contains the packet field value range:
determining a factor for each field in the rule, the factor comprising a number of possible values for the field, the packet field value range comprising two or more of the possible values;
multiplying all of the factors for the rule to produce a first product;
updating the factors to represent the packet field value range as a single possible value;
multiplying all of the updated factors for the rule to produce a second product; and
subtracting the second product from the first product to produce the cost reduction corresponding to the packet field value range.

15. The optimizing rules compiler of claim 10, wherein the plurality of rules comprises a plurality of packet classification rules for classifying ingress and egress packets received by the network device, and wherein the plurality of rules comprises all packet classification rules to be loaded on a forwarding ASIC of the network device.

16. The optimizing rules compiler of claim 10, wherein the at least one hardware table comprises a ternary content addressable memory (TCAM).

17. A computer program product comprising a non-transitory computer-readable medium storing instructions executable by one or more processors to perform:
examining a plurality of rules to be stored in at least one hardware table, at least one of the rules specifying one or more corresponding packet field value ranges which are used to match packets;
for each packet field value range, determining a corresponding cost reduction that would result from replacing the packet field value range with a first entry in a summarization table;
identifying a first packet field value range corresponding to a greatest cost reduction; and
assigning the first packet field value range to a first entry in the summarization table.

18. The computer program product of claim 17, wherein the instructions are further executable to:
after assigning the first packet field value range to the first entry in the summarization table, iteratively performing for each of one or more additional entries in the summarization table:
examining the plurality of rules,
determining the cost reduction for each unallocated packet field value range,
identifying a corresponding additional packet field value range corresponding to a greatest cost reduction, and
assigning the corresponding additional packet field value range to the corresponding entry in the summarization table.

19. The computer program product of claim 18, wherein for each remaining packet field value range in the plurality of rules, the cost reduction corresponding to the packet field value range that would result from replacing the packet field value range with a second entry in the summarization table is determined based on previously assigned packet field value ranges being replaced by corresponding entries in the summarization table.

20. The computer program product of claim 17, wherein determining the cost reduction corresponding to each packet field value range comprises:
for a rule that contains the packet field value range:
determining a factor for each field in the rule, the factor comprising a number of possible values for the field, the packet field value range comprising two or more of the possible values;
multiplying all of the factors for the rule to produce a first product;
updating the factors to represent the packet field value range as a single possible value;
multiplying all of the updated factors for the rule to produce a second product; and
subtracting the second product from the first product to produce the cost reduction corresponding to the packet field value range.
